(19) United States
(12) Patent Application Publication
(10) Pub. No.: US 2002/0001256 A1
(43) Pub. Date: Jan. 3, 2002

(54) Footstep bearing for impeller shafts

(76) Inventor: Wolfgang Dietz, Krefeld (DE)

Correspondence Address: BAYER CORPORATION, PATENT DEPARTMENT, 100 BAYER ROAD, PITTSBURGH, PA, 15205, US

(21) Appl. No.: 09/870,005

(22) Filed: May 30, 2001

(30) Foreign Application Priority Data
Jun. 2, 2000 (DE) 10027343.2

(51) Int. Cl. B01F 15/00

(52) U.S. Cl. 366/331; 277/408; 277/411; 277/422; 384/276; 416/174

(57) ABSTRACT

A footstep bearing for an impeller shaft of a container stirring mechanism is described. The footstep bearing has at least one shaft butt end (1) that is mounted, in particular, on the wall (2) of the container (16), and an impeller shaft (9) with a gap (13) in the region of the engagement between shaft butt end (1) and impeller shaft (9). In the region of the gap (13), the shaft butt end (1) and/or the impeller shaft (9) are/is provided on their surface with sliding elements on which the opposite surface of the impeller shaft (9) and/or the shaft butt end (1) slide and the shaft butt end (1) has means (11) for the passage of a flushing fluid (3) through the gap (13) between impeller shaft (9) and shaft butt end (1).

The invention relates to a novel footstep-bearing design for impeller shafts, in particular reactor impeller shafts, comprising at least one shaft butt end mounted, in particular, on the wall of the container, and an impeller shaft, with a gap in the region of the engagement between shaft butt end and impeller shaft.

The invention relates, in particular, to a footstep-bearing design for impeller shafts that can no longer be mounted in an unsupported manner unilaterally on the drive side, but need a counterbearing at the shaft end. Said bearings, which are contained, for example, in reactors, are exposed in some cases to extreme conditions that may have a negative effect on the durability of the bearing since corrosive and/or abrasive substances destroy the sliding bearing prematurely. The footstep bearing is suitable, in particular, in the case of long impeller shafts having multistage stirring members that have large deflections of the impeller shaft as a consequence of high radial forces (slim, long stirred containers, such as, for example, reactors or fermenters).

During the treatment of fluids containing solids in reactors by means of stirring devices that have a footstep bearing at the base of the respective reactor, the problem occurs that the solids in the reaction fluid may settle in the footstep bearing. This always reduces the operating time of the reactors.

In stirrer engineering, a plurality of methods of solution are adopted as standard for mounting the impeller shaft in the product space:

The avoidance of a bearing in the stirred container inevitably results in thicker impeller shafts and very high forces of reaction on the remaining bearing of the drive side.

If a unilateral mounting is not expedient or economical, footstep bearings are frequently used at the end of the impeller shafts that have a sliding surface combination comprising a PFTE/glass compound and stainless steel and that are lubricated by the product (temperature limits at the friction surface <200° C. and the lack of abrasive solids).

In the case of higher temperatures and chemical resistance, coal/coke impregnated with antimony or special bronze bearings are often used.

If abrasive substances are present, suitable harder material pairs are also chosen (ceramic bearing, for example, of SiC or hard metal) so that the wear is delayed. Disadvantages are the brittleness and the sensitivity of the materials to thermal shock, and also the expensive materials and the complicated processing methods.

In the oxidation of hexane using boric acid, in particular, the footstep bearings of the impeller shafts used in the reactor were adversely affected to such an extent that they have to be renewed in some cases after just a few months of operating time.

In the present application case, the inadequate operating lives of the footstep bearings are the result of the combination of disadvantageous factors that can be described in detail as follows.

Cyclohexane is continuously oxidized to form cyclohexanone/cyclohexanol with atmospheric oxygen at enhanced pressure and enhanced temperature in a multistage stirred-container cascade. In addition to cyclohexane, boric acid is added to the reaction as a catalyst in the form of crystalline (and abrasive) solid. In addition, during the reaction, corrosive or abrasive by-products (such, as, for example, carboxylic acids and resinous solids) are formed that, in addition to the boric acid, wear the footstep bearing prematurely.

The object of the invention is to provide a bearing for an impeller shaft with which the processing of, in particular, reactive systems containing abrasive solids can be ideally controlled with as long as possible service life of the bearing and that avoids the further disadvantages mentioned above.

The object is achieved, according to the invention, in that, in a footstep bearing of an impeller shaft of the type mentioned at the outset, the shaft butt end mounted on the container wall is provided on its surface with sliding elements on which the inside of the impeller shaft slides and in that the gap between shaft butt end and impeller shaft end can be flushed with a flushing fluid.

The present invention provides a footstep bearing for an impeller shaft of a container stirring mechanism having at least one shaft butt end mounted, in particular, on the wall of the container and an impeller shaft that engage in one another, with a gap in the region of the engagement of shaft butt end and impeller shaft, characterized in that the shaft butt end and/or the impeller shaft are/is provided on their surface in the region of the gap with sliding elements, preferably pimples, ring segments or axially disposed strips, on which the respective opposite surface of the impeller shaft and/or of the shaft butt end slides, and in that the shaft butt end has means, preferably a bore, for the passage of a flushing fluid through the gap between impeller shaft and shaft butt end.

Preferred is an embodiment of the footstep bearing in which the impeller shaft has the gap in which the shaft butt end engages.

In a preferred embodiment of the invention, an additional ring seal that makes possible the passage of the flushing fluid is provided between impeller shaft and shaft butt end to guide the impeller shaft and that ensures the maintenance of the pressure difference between the gap and the container.

The sliding elements are composed preferably of a plastic having low coefficient of friction.

Particularly preferably, the plastic for the sliding elements is a plastic based optionally on carbon-fibre-reinforced or glass-fibre-reinforced polytetrafluoroethylene (PTFE) and/or polyetherether ketone (PEEK), in particular a high-temperature composite material based on polytetrafluoroethylene (PTFE) and/or polyetherether ketone (PEEK).

In a preferred embodiment of the invention, sliding elements of a different material are disposed on the shaft butt end. Particularly preferably, sliding elements of polytetrafluoroethylene (PTFE) or polyetherether ketone (PEEK) are alternately disposed on the shaft butt end.

The plastic for the ring seal is, in particular, a plastic having low coefficient of friction and high wear resistance, in particular a plastic based optionally on carbonfibre-reinforced or glass-fibre-reinforced polytetrafluoroethylene (PTFE) and/or polyetherether ketone (PEEK), in particular a high-temperature composite material based on polytetrafluoroethylene (PTFE) and/or polyetherether ketone (PEEK), particularly preferably based on polyetherether ketone (PEEK).

In a preferred variant of the footstep bearing, the sliding elements are disposed on a sheath that is joined to the shaft butt end and is, in particular, detachable.

For the purpose of replacing the worn parts, the impeller shaft is formed, in a preferred embodiment of the footstep bearing, at least from two parts and has, in particular, a detachable metal sleeve that makes contact with the sliding elements. In this connection, the metal sleeve is sunk into the shaft butt end.

If a suitable flushing fluid cannot be supplied to the footstep bearing and enter the container via the restrictor gap of the ring seal, a suitable external cooling and

lubricating circuit can be used that has a pump and heat exchanger, the annular gap then being sealed.

In addition, an equalizing reservoir that has a pressurized blanket, for example, with nitrogen should expediently be added in a similar way to that usual in the case of sealing fluids of an axial seal.

The advantages and effects of the invention may be described as follows:

Flushing fluid (for example, hexane) is introduced through the shaft butt end that is mounted on the reactor via an axial bore, the flushing fluid flowing through the footstep bearing from top to bottom and flowing round the sliding elements while doing so. The flushing fluid leaves the footstep bearing via the restrictor gap of the preferred sealing ring mounted in a floating manner.

The flushing fluid escapes at high velocity into the reactor space through the narrow restrictor gap. The pressure loss due to this results in a markedly higher pressure level in the footstep bearing, with the result that the penetration of solid (e.g. boric acid) is safely prevented.

Owing to the preferred “floating” guidance of the sealing ring, the sealing ring adapts to the deflections of the impeller shaft without becoming worn, with the result that the very narrow gap geometry is maintained. In addition, the sealing ring is pressed by spring force and by the higher internal pressure against the housing, which ensures that the flushing fluid flows through the restrictor gap.

In addition to the function described of keeping boric acid out of the footstep bearing, the flushing fluid has a further object of cooling the sliding elements (which improves the service life of the footstep bearing) and also of reducing the friction (sliding film effect).

Parts of the sliding elements and also of the sealing ring are preferably made from a plastic compound that has tribological properties (for example, matrix PEEK) and that has a very high wear resistance.

Because of these properties, the metallic running surface should optionally be matched with regard to hardness and surface finish.

As a result of the preferred mixture of PEEK and PTFE pimples, the sliding friction is favourably influenced by the PTFE running film that forms since mixed friction occurs under the given conditions in the footstep bearing (no permanent lubricating film).

The invention is explained further by way of example below with reference to the figures.

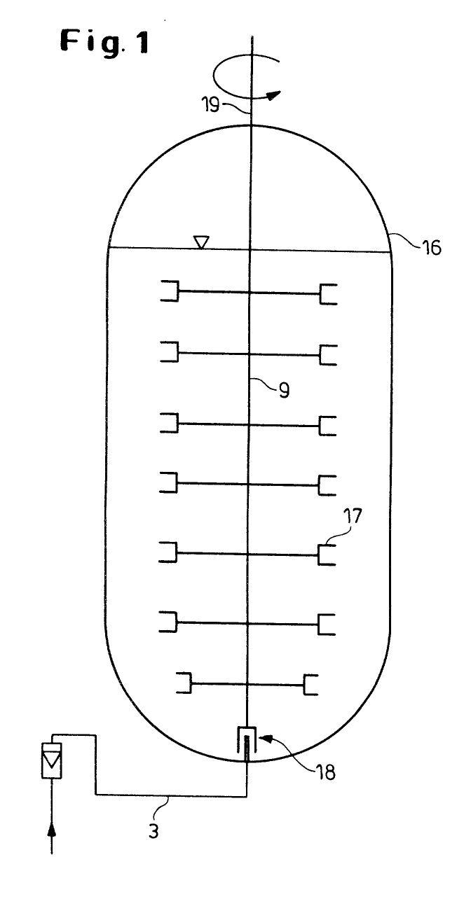

FIG. 1 shows a stirred container with impeller shaft and footstep bearing according to the invention,

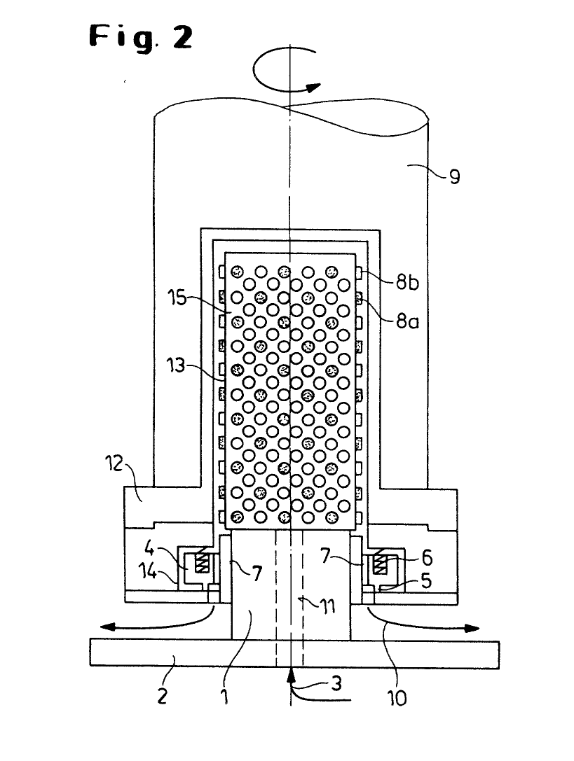

FIG. 2 shows a cross section through a preferred embodiment of the footstep bearing.

### EXAMPLE

FIG. 1 shows the stirred container 16 with the rotating impeller shaft 9, including the multistage stirring members 17, and the footstep bearing 18 situated in the stirred container 16. Normally, the drive (not shown here) with a fixed bearing for absorbing the axial and radial shaft forces and with a shaft seal is situated at the upper part 19 of the stirred container 16, while only the shaft forces radial with respect to the shaft 9 are absorbed by the footstep bearing 18 at the lower end of the shaft 9. To protect the sliding surfaces of the footstep bearing 18 from foreign substances, a clean sealing fluid is continuously fed into the footstep bearing through the inlet line 3.

FIG. 2 shows the structure of the footstep bearing in cross section. Welded onto the container wall 2 of a hexane reactor, which is shown in FIG. 1 only as a detail, is the shaft butt end 1. The shaft butt end 1 and the container wall 2 have a passage 11 for a flushing fluid that is connected to an external feed line 3. The passage 11 opens into a cylindrical gap 13 in the end of the impeller shaft 9. In the present embodiment, the gap 13 is surrounded by a specially formed stainless steel sleeve 12 that is screwed into the end of the impeller shaft 9.

Disposed on the inside of the metal sleeve 12 at that side of the metal sleeve 12 directed towards the container wall 2 is an annular groove 14. The groove 14 accommodates a ring seal 4 whose sealing lip 5 is pressed against the lower surface of the sealing groove 14 by compression springs 6 on its upper side. In the region of the groove 14, a shaft protection sleeve 7 of surface-refined stainless steel is mounted on the circumference of the shaft butt end 1 and screwed to it. Mounted above the shaft protection sleeve 7 on the circumference of the shaft butt end 1 and screwed to the shaft butt end 1 is a sheath 15 that is provided in turn with a multiplicity of sliding pimples 8 on its surface. In this connection, the majority of the sliding pimples 8 are composed of polytetrafluoroethylene containing hard coke (pimples 8b) and the further pimples 8a are composed of carbon-fibre-reinforced PEEK.

The flushing fluid 3, which is identical with the reaction fluid used in the reactor, enters the gap 13, as described above, through the passage 11. The flushing fluid 3 flows past the sliding pimples 8, passes through the gap between the shaft protection sleeve 7 and the sealing ring 4 and enters the reactor through the unobstructed gap 10 between the metal sleeve 12 and the container wall 2.

The footstep bearing was used in a hexane oxidation reactor. In the latter, the abrasive and corrosive solid boric acid and also solid by-products (resin) were the main burden on the bearing embodiment.

With the aid of the footstep bearing described above, it was possible to prolong the service life of the reactor impeller shaft 9 compared with a conventional reactor impeller shaft from typically about three months to two years without any perceptible wear.

1. Footstep bearing for an impeller shaft of a container stirring mechanism having at least one shaft butt end (1) mounted, in particular, on the wall (2) of the container (16), and an impeller shaft (9), which shaft end and impeller shaft engage in one another, with a gap (13) in the region of the engagement of the shaft butt end (1) and the impeller shaft (9), characterized in that the shaft butt end (1) and/or the impeller shaft (9) are/is provided on their surface in the region of the gap (13) with sliding elements (8), preferably pimples, ring segments or axially disposed strips, on which the respective opposite surface of the impeller shaft (9) and/or of the shaft butt end (1) slides, and in that the shaft butt end (1) has means (11), preferably a bore (11), for the passage of a flushing fluid (3) through the gap (13) between impeller shaft (9) and shaft butt end (1).

2. Footstep bearing according to claim 1, characterized in that the impeller shaft (9) has the gap (13) in which the shaft butt end (1) engages.

3. Footstep bearing according to claim 1 or 2, characterized in that an additional ring seal (4) that makes possible the passage of the flushing fluid (3) is provided between impeller shaft (9) and shaft butt end (1) to guide the impeller shaft (9).

4. Footstep bearing according to one of claims 1 to 3, characterized in that the sliding elements (8) are composed of a plastic having a low coefficient of friction and also a high resistance to wear.

5. Footstep bearing according to claim 4, characterized in that the plastic for the sliding elements (8) is a plastic based optionally on carbon-fibre-reinforced or glass-fibre-reinforced polytetrafluoroethylene (PTFE) and/or polyetherether ketone (PEEK), in particular a high-temperature composite material based on polytetrafluoroethylene (PTFE) and/or polyetherether ketone (PEEK).

6. Footstep bearing according to one of claims 1 to 5, characterized in that sliding elements (8) of a different material are disposed on the shaft butt end (1).

7. Footstep bearing according to claim 6, characterized in that sliding elements (8) of polytetrafluoroethylene (PTFE) or polyetherether ketone (PEEK) are alternately disposed on the shaft butt end (1).

8. Footstep bearing according to one of claims 1 to 7, characterized in that the plastic for the ring seal (4) is a plastic having a low coefficient of friction and high wear resistance, in particular a plastic based optionally on carbon-fibre-reinforced or glass-fibre-reinforced polytetrafluoroethylene (PTFE) and/or polyetherether ketone (PEEK), in particular a high-temperature composite material based on polytetrafluoroethylene (PTFE) and/or polyetherether ketone (PEEK), particularly preferably based on polyetherether ketone (PEEK).

9. Footstep bearing according to one of claims 1 to 8, characterized in that the sliding elements (8) are disposed on a sheath (15) that is joined to the shaft butt end (1) and is, in particular, detachable.

10. Footstep bearing according to one of claims 1 to 9, characterized in that the end of the impeller shaft (9) is formed from at least two parts and has, in particular, a detachable metal sleeve (12) that makes contact with the sliding elements (8).

11. Footstep bearing according to claims 1 to 10, characterized in that the passage (11) for the flushing fluid (3) is extended by a feedback line and the flushing fluid is fed back not into the reactor but into an external sealing fluid circuit with equalizing reservoir, the restrictor gap to the shaft being sealed.
